(19) United States
(12) Patent Application Publication
(10) Pub. No.: US 2025/0210284 A1
(43) Pub. Date: Jun. 26, 2025

(54) Contactor With Multiple Contacts for Conducting and Limiting a Current

(71) Applicant: Bayerische Motoren Werke Aktiengesellschaft, Muenchen (DE)

(72) Inventors: Philipp LEUNER, Muenchen (DE); Florian PRITSCHER, Landshut (DE)

(21) Appl. No.: 18/851,115

(22) PCT Filed: Jun. 14, 2023
(86) PCT No.: PCT/EP2023/065949

§ 371 Date: Sep. 26, 2024

(30) Foreign Application Priority Data
Jul. 4, 2022 (DE) 10 2022 116 580.9

(51) Int. Cl. H01H 3/38; H01H 1/20; H01H 9/40; H01H 9/42

(52) U.S. Cl. CPC H01H 3/38; H01H 1/20; H01H 9/40; H01H 9/42

(57) ABSTRACT

A contactor for wiring components of an onboard electrical system, includes: a stationary contact unit for electrically connecting to the onboard electrical system components; a movable contact unit, and an actuation unit for switching the contactor by switching the movable contact unit between a closed state and an open state. The movable contact unit has at least one first contact element for conducting a current and at least one second contact element for conducting and limiting the current during the switching process. A first electric contact formed between the stationary contact unit and the at least one first contact element has a lower transmission resistance than a second electric contact formed between the stationary contact unit and the at least one second contact element. The actuation unit is designed to switch the contact elements between the closed state and the open state in a staggered manner relative to one another so that temporarily only the at least one second contact element contacts the stationary contact unit in order to limit the current during the switching process.

### BACKGROUND AND SUMMARY

The invention relates to a contactor for an on-board electrical network of a motor vehicle, for wiring components of the on-board electrical network. The contactor comprises a stationary contact unit for electrically connecting to at least two on-board electrical network components, and a moveable contact unit which, in a closed state of the contactor, is contact-connected to the stationary contact unit and, in an open state of the contactor, is at least partially separated from the stationary contact unit. The on-board electrical network moreover comprises an actuation unit for switching the contactor by the switchover of the moveable contact unit between the closed state and the open state. The invention further relates to an on-board electrical network for a motor vehicle.

The focus of the present case is on-board electrical networks, in particular high-voltage on-board electrical networks, for electrically powered motor vehicles. On-board electrical networks of this type comprise on-board electrical network components, for example an electrical energy store, an electric machine, a power electronics circuit, etc., which can be electrically interconnected by means of electric power lines. In these lines, contactors can be arranged for the interruption of the line, and thus for the isolation of on-board electrical network components. In particular, these contactors are designed for switching high loads, as a result of which, in many cases, complex measures are implemented for the prevention of any fusion of the contacts of the contactor associated with the closing of the contactor, or for the reduction of arcing associated with the opening of the contactor, in order to ensure a long-term serviceability of the contactor. Measures of this type include, for example, the provision of arc quenching chambers or the enclosure of the contactor in a vacuum chamber or in a protective gas atmosphere. Upon the interruption of the line, as a result of an overcurrent flowing in the line, for example a short-circuit current associated with a defect in one of the on-board electrical network components, destruction of the contactor can moreover occur as a result of levitation.

The object of the present invention is to provide a simple solution by which unwanted states associated with the switching of a contactor of a motor vehicle, for example arcing or the tendency for fusion between contacts of the contactor, can at least be reduced.

According to the invention, this object is fulfilled by a contactor and by an on-board electrical network having the features claimed in the respective independent patent claims. Advantageous embodiments of the invention are the subject matter of the dependent patent claims, the description and the FIGURE.

A contactor according to the invention for an on-board electrical network of a motor vehicle is employed for the electrical wiring of on-board electrical network components of the on-board electrical network. The contactor comprises a stationary contact unit for electrically connecting to at least two on-board electrical network components, and a moveable contact unit which, in a closed state of the contactor, is contact-connected to the stationary contact unit and, in an open state of the contactor, is at least partially separated from the stationary contact unit. The contactor moreover comprises an actuation unit for switching the contactor by the switchover of the moveable contact unit between the closed state and the open state.

The moveable contact unit comprises at least one first contact element for conducting a current which flows via the moveable contact unit in the closed state of the contactor, and at least one second contact element for conducting and limiting the current during the switching process. A first electric contact formed between the stationary contact unit and the at least one first contact element assumes a first transmission resistance, and a second electric contact formed between the stationary contact unit and the at least one second contact element assumes a higher second transmission resistance. The actuation unit is designed to execute the switchover of the at least one first contact element and the at least one second contact element between the closed state and the open state in a staggered manner in relation to one another such that, for limiting the current during switching, temporarily, only the at least one second contact element is contact-connected to the stationary contact unit.

The invention moreover relates to an on-board electrical network for a motor vehicle, comprising at least two on-board electrical network components and at least one contactor according to the invention. In particular, the on-board electrical network is a high-voltage on-board electrical network and comprises high-voltage components, for example a traction accumulator, an inverter, an electric machine, a charging device for charging the traction accumulator, etc. The on-board electrical network components are interconnected, for example, by means of electric power lines. In at least one of these lines, at least one contactor is arranged which is designed, in the closed state, to electrically connect the on-board electrical network components and to conduct a current via the line and, in an open state, to interrupt the line, and thus to galvanically isolate the on-board electrical network components.

To this end, the contactor comprises the stationary contact unit, which is connected to the on-board electrical network components. For example, the stationary contact unit comprises two stationary contact elements, which are separated from one another and are not contact-connected, in particular in the form of contact rails wherein, in each case, one on-board electrical network component is respectively connected to one stationary contact element, for example via one respective line section of the line. The moveable contact unit is designed to electrically connect or isolate the stationary contact elements, and thus the on-board electrical network components. In the open state of the contactor, the moveable contact unit, for example by means of an air gap, is arranged with a spacing from at least one of the two stationary contact elements. In the closed state of the contactor, the moveable contact unit is arranged in contact with both stationary contact elements.

For the switching of the contactor, and thus for the closing or opening thereof, the moveable contact unit is moved by the actuation unit of the contactor and, in particular, travels in a linear direction in relation to the stationary contact unit. To this end, the actuation unit comprises a drive element and a force transmission element, wherein the drive element is designed to operate the force transmission element, which is mechanically connected to the moveable contact unit, for the switching of the contactor. The drive element comprises, for example, an electromagnet, which can be energized by the incorporation thereof in a power circuit. The force transmission element can be, for example, a tie rod.

The contactor is configured as a multiple contact system. To this end, the moveable contact unit comprises two different moveable contact elements which, upon switching, are contact-connected to the stationary contact unit in a staggered manner. The at least one first contact element is thus a current-carrying contact element which is designed, in the closed state, to conduct at least a major proportion of the current via the contactor. The at least one second contact element is configured for load switching and, upon opening and closing, limits the current flowing via the contactor.

The moveable contact elements can be configured, for example, as contact pins which are displaceable in relation to the stationary contact rails. For example, the moveable contact unit can comprise two first current-carrying contact bridges and a load-switching second contact bridge, which is arranged between the two first current-carrying contact bridges. The force transmission element of the actuation unit can be configured, for example, in the form of a fork-shaped tie rod wherein, in each case, one tine of the fork-shaped tie rod is respectively connected to one of the moveable contact elements. The stationary contact unit can comprise two contact studs wherein, in each case, one contact stud is electrically and mechanically connected to a contact rail, and projects from the contact rail in the direction of the moveable contact unit. The contact studs penetrate, for example, the respective contact rail, wherein a respective head of the studs projects in the direction of the moveable contact unit and forms a contact surface for the second contact bridge. In the closed state, the two first contact bridges are contact-connected to the contact rails to form the first electrical contact, and the contact studs are contact-connected to the second contact bridge to form the second electrical contact.

The current-limiting function during the closing of the contactor is employed for reducing any tendency towards fusion, in particular for preventing any fusion of the stationary and the moveable contact units. The current-limiting function during the opening of the contactor is employed for reducing any arcing between the stationary and the moveable contact units, and for preventing any destruction of the contactor associated with overcurrent-induced levitation. The actuation unit is therefore designed, upon the closing of the contactor, firstly to contact-connect the at least one second contact element to the stationary contact unit and, upon the opening of the contactor, firstly to release the at least one first contact element from the stationary contact. In other words, upon the closing of the contactor, the at least one second load-switching contact element is configured as a leading contact element and, upon the opening of the contactor, as a lagging contact element to the at least one first current-carrying contact element.

For the configuration of the at least one first contact element as a current-carrying contact element, and for the configuration of the at least one second contact element as a load-switching contact element, the associated electrical contacts between the respective contact element and the stationary contact unit assume different transmission resistances or contact resistances. The first transmission resistance configured between the stationary contact unit and the at least one first contact element is thus lower than the second transmission resistance configured between the stationary contact unit and the at least one second contact element. Both transmission resistances are configured as low-impedance resistances. For example, the first transmission resistance lies in the micro-ohm range, whereas the second transmission resistance lies in the milli-ohm range. For example, in order to deliver different transmission resistances, one surface of the at least one first contact element can comprise a first material, and one surface of the at least one second contact element can comprise a second material. The at least one first contact element and the at least one second contact element can be comprised of different materials or alloys, or can assume different surface coatings. For example, the first material can be copper, and the second material can be steel.

As a result of the low transmission resistance, the at least one first contact element conducts the major proportion of current in the closed state of the contactor. Upon the opening of the contactor, initially, the at least one first contact element is released from the stationary contact unit, and the current is entirely commutated to the still contact-connected second contact element which, on the grounds of the higher transmission resistance, limits the current. The second contact element is then also released from the stationary contact unit wherein, as a result of the reduced current, the risk of arcing is at least reduced, or any levitation of the moveable contact unit associated with an overcurrent flowing via the contactor upon the opening of the contactor is prevented. Upon the closing of the contactor, initially, the at least one second contact element is contact-connected to the stationary contact unit and limits the current which, upon the subsequent contact-connection of the at least one first contact element, is then commutated to the at least one first contact element, which assumes current conduction in the closed state of the contactor.

A contactor of this type with an integrated current-limiting function is configured in a particularly simple manner, and can reliably prevent damage to the contactor during switching processes of the contactor.

It has proved to be advantageous that the actuation unit comprises a spring device, by means of which the at least one second contact element, in an open state of the contactor, is mounted closer to the stationary contact unit than the at least one first contact element, such that the at least one second contact element, upon the closing of the contactor, is contact-connected to the stationary contact unit in advance of the at least one first contact element, and by means of which the at least one second contact element, upon the opening of the contactor from a closed state of the contactor, is compressed against the stationary contact unit for a longer duration than the least one first contact element, in order to permit an earlier release of the at least one first contact element from the stationary contact unit upon the opening of the contactor. The time delay for the contact-connection of the moveable contact unit upon the switching of the contactor is thus achieved by exclusively mechanical means. For example, the spring device comprises at least one first compression spring for compressing the at least one first contact element against the stationary contact unit, and at least one second compression spring for compressing the at least one second contact element against the stationary contact unit wherein, in an open state of the contactor, the at least one first compression spring assumes a first length, and the at least one second compression spring assumes a longer second length, in comparison with the first length. The compression springs are employed, on the one hand, to deliver effective contact between the moveable contact elements and the stationary contact unit in the closed state and, on the other, to enable the execution of staggered contact-connection, on the grounds of the differing spring lengths.

Embodiments contemplated with respect to the contactor according to the invention, and the advantages thereof, apply correspondingly to the on-board electrical network according to the invention.

Further features of the invention proceed from the claims, the FIGURE, and the description of the FIGURE. Features and combinations of features specified in the description provided heretofore, together with features and combinations of features specified hereinafter in the description of the FIGURE and/or which are represented exclusively in the FIGURE, can not only be employed in the respectively indicated combination, but also in other combinations, or in isolation.

The invention is described in greater detail hereinafter with respect to a preferred exemplary embodiment, and with reference to the drawing.

### BRIEF DESCRIPTION OF THE DRAWINGS

FIG. 1 shows a contactor for an on-board electrical network of a motor vehicle.

### DETAILED DESCRIPTION OF THE DRAWINGS

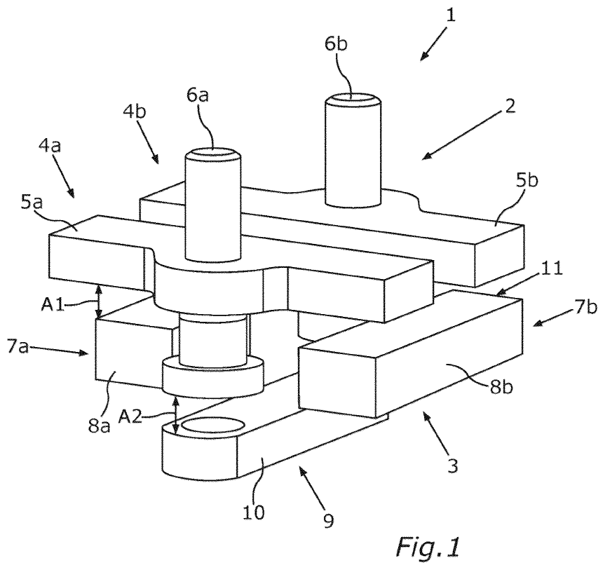

The single FIGURE, FIG. 1, shows a contactor for an on-board electrical network of a motor vehicle (not shown), for the electrical connection and galvanic isolation of on-board electrical network components of the on-board electrical network. To this end, the contactor 1 is arranged in a line which connects the on-board electrical network components. The contactor 1 comprises a stationary contact unit 2 and a moveable contact unit 3. The stationary contact unit 2 comprises two stationary contact elements 4a, 4b wherein, in each case, one stationary contact element 4a, 4b can be connected to an on-board electrical network component by means of a line section of the electric power line. Each stationary contact element 4a, 4b comprises a contact rail 5a, 5b, and a contact stud 6a, 6b which is electrically and mechanically connected to the contact rail 5a, 5b.

In the present case, the contact unit 3 which is moveable in relation to the stationary contact unit 2 comprises two first moveable contact elements 7a, 7b, in the form of first contact bridges 8a, 8b, and a second moveable contact element 9 in the form of a second contact bridge 10. In the present case, the second contact bridge 10 is arranged between the two first contact bridges 8a, 8b. The moveable contact elements 7a, 7b, 9 are displaceable in common by means of an actuation unit of the contactor 1, which is not represented here. In the open state of the contactor 1 represented here, an air gap 11 is configured between the moveable contact elements 7a, 7b, 9 and the stationary contact elements 4a, 4b. In the closed state of the contactor 1, the moveable contact elements 7a, 7b, 9 are arranged in contact with the stationary contact elements 4a, 4b. In the present case, the moveable first contact bridges 8a, 8b are arranged in contact with the contact rails 5a, 5b, and the moveable second contact bridge 10 is arranged in contact with the contact studs 6a, 6b. The first moveable contact elements 7a, 7b are thus current-carrying contact elements and, in the closed state, conduct current via the contactor. The second moveable contact element 9 is a load-switching contact element, and is employed for current limitation during switching, i.e. upon the opening or closing of the contactor 1. To this end, a first transmission resistance between the first moveable contact elements 7a, 7b and the stationary contact unit 2 is lower than a second transmission resistance between the second moveable contact element 9 and the stationary contact unit 2. For example, the moveable contact elements 7a, 7b, 9 can be comprised of different materials, and can thus assume different internal resistances.

In the event of the disconnection of a load, current limitation is executed by the second transmission resistance, and arcing at the time of separation is thus reduced wherein, upon the opening of the contactor 1, initially, the first moveable contact bridges 8a, 8b are released or separated from the contact rails 5a, 5b, and the second moveable contact bridge 10 remains in short-term contact with the contact studs 6a, 6b. In the event of the flow of a short-circuit current via the line, which necessitates an opening of the contactor 1 in order to prevent any destruction of the on-board electrical network components, the exclusively current-carrying contact bridges 5a, 5b also open by the levitation of the electrical contact, and the current is commutated to the load-switching contact bridge 10, the internal resistance of which limits the current to the extent that no disengagement of the contact occurs. A potential rupture of the contactor 1 associated with the high pressure generated by a sustained arc can be prevented accordingly. In the event of the switch-in of a capacitive load, for example an inverter, current limitation is also executed by the second transmission resistance, thereby resulting in reduced arcing wherein, upon the closing of the contactor 1, initially, the moveable second contact bridge 10 is contact-connected to the contact studs 6a, 6b and, a short time thereafter, the first moveable contact bridges 8a, 8b are contact-connected to the contact rails 5a, 5b.

This staggered contact-connection of the moveable contact elements 7a, 7b, 9 to the stationary contact unit 2 upon the switching of the contactor 1, which occurs, for example, within an interval of milliseconds, can be achieved by exclusively mechanical measures wherein, in the open state, the second moveable contact element 9, by way of a spring device, is mounted closer to the stationary contact elements 4a, 4b than the first moveable contact elements 7a, 7b. Thus, in this case, in the open state of the contactor 1, the current-carrying contact bridges 8a, 8b assume a first clearance A1 to the contact rails 5a, 5b, and the second, load-switching contact bridge 10 assumes a smaller second clearance A2 to the contact studs 6a, 6b, in comparison with the first clearance A1. To this end, the first contact bridges 8a, 8b can be connected, for example, to a first compression spring, and the second contact bridge 10 can be connected to a second compression spring, wherein the first compression spring, in the unloaded open state of the contactor 1, assumes a shorter length than the second compression spring. The compression springs are also employed for compressing the contact bridges 8a, 8b, 10 against the stationary contact elements 4a, 4b, and upon the opening of the contactor 1, for compressing the second contact bridge 10 against the contact studs 6a, 6b for a longer duration than the compression of the first contact bridges 8a, 8b against the contact rails 5a, 5b.

1.-10. (canceled)

11. A contactor for an on-board electrical network of a motor vehicle for electrically wiring on-board electrical network components of the on-board electrical network, comprising:
a stationary contact unit for electrically connecting to the on-board electrical network components;
a moveable contact unit which, in a closed state of the contactor, is contact-connected to the stationary contact unit and, in an open state of the contactor, is at least partially separated from the stationary contact unit; and
an actuation unit for switching the contactor by switching over the moveable contact unit between the closed state and the open state, wherein
(i) the moveable contact unit comprises:
at least one first contact element for conducting a current which flows via the moveable contact unit in the closed state of the contactor, and at least one second contact element for conducting and limiting the current during the switching of the contactor, wherein a first electric contact formed between the stationary contact unit and the at least one first contact element assumes a first transmission resistance, and a second electric contact formed between the stationary contact unit and the at least one second contact element assumes a second, higher, transmission resistance, and
(ii) the actuation unit is configured to execute the switchover of the at least one first contact element and the at least one second contact element between the closed state and the open state in a staggered manner in relation to one another such that, for limiting the current during switching, temporarily, only the at least one second contact element is contact-connected to the stationary contact unit.

12. The contactor according to claim 11, wherein
the actuation unit, for executing the staggered switchover, is configured to:
upon closing of the contactor, for reducing a tendency towards fusion, firstly, contact-connect the at least one second contact element to the stationary contact unit, and
upon opening of the contactor, for reducing arcing, firstly, release the at least one first contact element from the stationary contact unit.

13. The contactor according to claim 12, wherein
the actuation unit comprises a spring device, by which the at least one second contact element, in an open state of the contactor, is mounted closer to the stationary contact unit than the at least one first contact element and, upon opening of the contactor, is compressed against the stationary contact unit for a longer duration than the least one first contact element.

14. The contactor according to claim 13, wherein
the spring device comprises at least one first compression spring for compressing the at least one first contact element against the stationary contact unit, and at least one second compression spring for compressing the at least one second contact element against the stationary contact unit, wherein
in an open state of the contactor, the at least one first compression spring assumes a first length, and the at least one second compression spring assumes a longer second length, in comparison with the first length.

15. The contactor according to claim 11, wherein
the actuation unit comprises a drive element and a force transmission element in the form of a fork-shaped tie rod wherein, in each case, one tine of the fork-shaped tie rod is respectively connected to one of the moveable contact elements, and wherein the drive element is designed to operate the force transmission element for switching the contactor.

16. The contactor according to claim 11, wherein
in order to deliver different transmission resistances, one surface of the at least one first contact element comprises a first material, and one surface of the at least one second contact element comprises a second material.

17. The contactor according to claim 11, wherein
the stationary contact unit comprises two stationary contact rails wherein, in each case, one contact rail is connectable to an on-board electrical network component, and
the at least one first contact element is configured as a first contact bridge which is displaceable in relation to the two stationary contact rails, and
the at least one second contact element is configured as a second contact bridge which is displaceable in relation to the two stationary contact rails.

18. The contactor according to claim 17, wherein
the moveable contact unit comprises two first contact bridges and a second contact bridge which is arranged between the two first contact bridges.

19. The contactor according to claim 17, wherein
the stationary contact unit comprises two contact studs wherein, in each case, one contact stud is electrically and mechanically connected to a contact rail, and projects from the respective contact rail in a direction of the moveable contact unit, and
in the closed state, the two contact studs are contact-connected to the second contact bridge and the contact rails are contact-connected to the two first contact bridges.

20. An on-board electrical network for a motor vehicle, comprising:
at least two on-board electrical network components; and
at least one contactor according to claim 11,
wherein the contactor is electrically connected to the at least two on-board electrical network components.
